(19) United States
(12) Patent Application Publication
(10) Pub. No.: US 2015/0235307 A1
(43) Pub. Date: Aug. 20, 2015

(54) Online Marketplace System with a Bidding Platform

(71) Applicants: John Raymond Webb, Fairfield, CT (US); Richard Barrett Webb, Jersey City, NJ (US); Yiyin Wang, Jersey City, NJ (US)

(72) Inventors: John Raymond Webb, Fairfield, CT (US); Richard Barrett Webb, Jersey City, NJ (US); Yiyin Wang, Jersey City, NJ (US)

(21) Appl. No.: 14/701,576

(22) Filed: May 1, 2015

(51) Int. Cl. G06Q 30/08; G06Q 30/02; G06Q 30/06

(52) U.S. Cl. CPC G06Q 30/08; G06Q 30/0611; G06Q 30/0203

(57) ABSTRACT

Disclosed is an online marketplace system that includes a marketplace platform, a database, and an analytics module. The marketplace platform includes a customer portal and a business portal, wherein the customer portal is used by a customer to submit a request for quote and the business portal is used by selected vendors to input offers or bids. Once the customer selects a vendor to fulfill a product and/or service request, the platform prompts the customer to complete a survey before confirming the purchase. The analytics module gathers the survey data as well as other relevant market data to generate a report for the vendors, whereby the vendors can use the report to assess their performance and make improvements to their businesses. The analytics module is further configured to provide market data to the customers to allow customers to make informed decisions when selecting venders to fulfill the request.

### FIELD OF THE INVENTION

The present invention generally relates to an online marketplace system and method of use. More particularly, the present invention is directed to an online marketplace that provides a bidding platform, wherein the marketplace connects customers with businesses to streamline product and service request and fulfillment processes.

### BACKGROUND OF THE INVENTION

Online bidding platforms and auction platforms are utilized to conduct sales by improving effectiveness of the sourcing process and facilitating access to new suppliers, providers, and/or businesses. Many existing online bidding and auction platforms conduct reverse auctions, which is where vendors compete to obtain business from the customer and prices typically decrease as the vendors undercut each other. These types of auctions are similar to traditional auction format in that the vendor with the lowest offered price is declared a winner after the auction finishes.

Existing bidding platforms, however, are limited in that winners are automatically selected based on the price offered. Thus, customers risk the chance of hiring an unqualified vendor, or a vendor that a customer does not want to hire. Some bidding platforms allow customers to choose a winner based on their preferences, and not solely based on the bid offered. These bidding platforms, however, are still limited in that they do not allow customers to make informed decisions. Thus, customers can select a winner solely based on first impressions or based on small amount of information conveyed from an incredible source. Furthermore, conventional bidding platforms provide no means for losing bidders to find out why they were not selected as a winner. In this regard, the losing bidders are unable to efficiently improve their performances to increase the chance of winning future bids, and can become discouraged from connecting with customers to grow their businesses.

### SUMMARY OF THE INVENTION

In view of the disadvantages inherent in the known types of online marketplaces now present in the prior art, the present invention provides an improved online marketplace system wherein the same can be utilized for connecting customers and local providers of goods and services.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as to prelude to the more detailed description that is disclosed later.

In one embodiment, the present system includes a plurality of vendor devices in connection with one or more customer devices and a server in a network. The server provides a marketplace platform, a database, and an analytics module. The marketplace platform includes a customer portal and a business portal, wherein the customer portal and the business portal are accessible through the customer devices and the vendor devices, respectively. Without limitation, the marketplace platform comprises a website, a web application, or a mobile application that allows customers to submit one or more requests for quote (RFQ) through the customer portal and that allows selected vendors to input offers or bids through the business portal.

Customers are prompted to complete a survey upon selecting a vendor to fulfill a product and/or service request. In this regard, the present invention provides customer feedback at the point of sale rather than at point of delivery. The survey data is provided to all of the participating vendors via the analytics module so as to allow the vendors to assess their performances and make improvements to increase customer engagement and grow sales. In some embodiments, the analytics module can also incorporate other market data to provide a more comprehensive and customized report that can be used by businesses to conduct self-assessment and/or that can be used to make specific suggestions for improvement. The market data can be also provided to the customers to allow customers to make better purchase decisions.

It is therefore an object of the present invention to provide an online marketplace system that provides a centralized location for transmitting messages between customers and all participating vendors.

It is another object of the present invention to provide an online marketplace system that provides analytics to allow customers to make informed decisions when selecting a vendor to fulfill a product and service request.

It is still another object of the present invention to provide an online marketplace system that provides sales leads to vendors to increase business transactions.

It is still another object of the present invention to provide an online marketplace system that provides analytics to allow vendors to evaluate themselves against competing vendors.

It is still another object of the present invention to provide an online marketplace system that comprises customer survey to provide feedback to losing and winning vendors.

A final object of the present invention to provide an online marketplace system that facilitates product and service request and fulfillment processes in a convenient manner for both customers and vendors.

In the light of the foregoing, these and other objects are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is a flow chart illustrating the method of the present invention.

FIG. 2 is an exemplary schematic diagram of the present invention.

FIG. 3A shows an exemplary diagram of a customer interface.

FIG. 3B shows an exemplary diagram of a business interface.

FIG. 4 shows an exemplary data flow diagram of the present invention.

### DETAILED DESCRIPTION OF THE INVENTION

The present invention is directed towards an online marketplace system that comprises a bidding platform. For purposes of clarity, and not by way of limitation, illustrative views of the present online marketplace system are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” unless specified otherwise or clear from context to be directed to a singular form. It is to be appreciated that determinations or inferences referenced throughout the subject specification can be practiced through the use of artificial intelligence techniques.

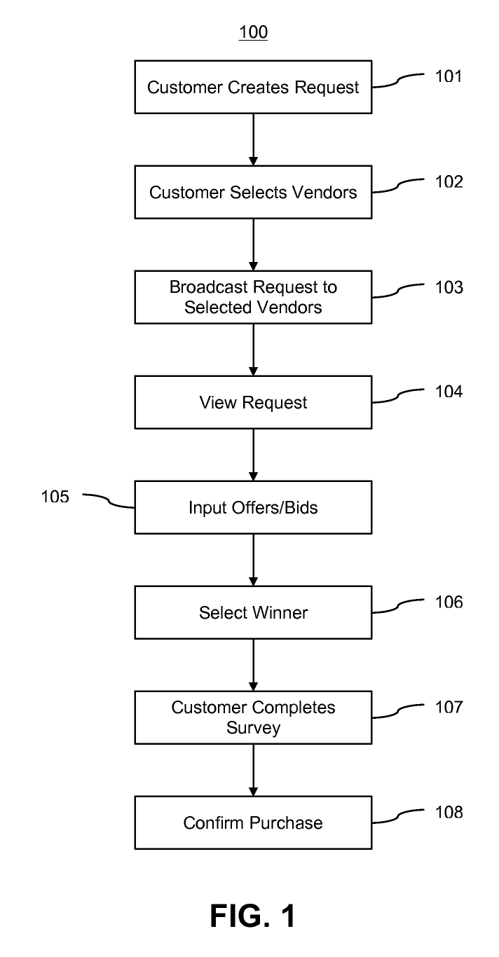

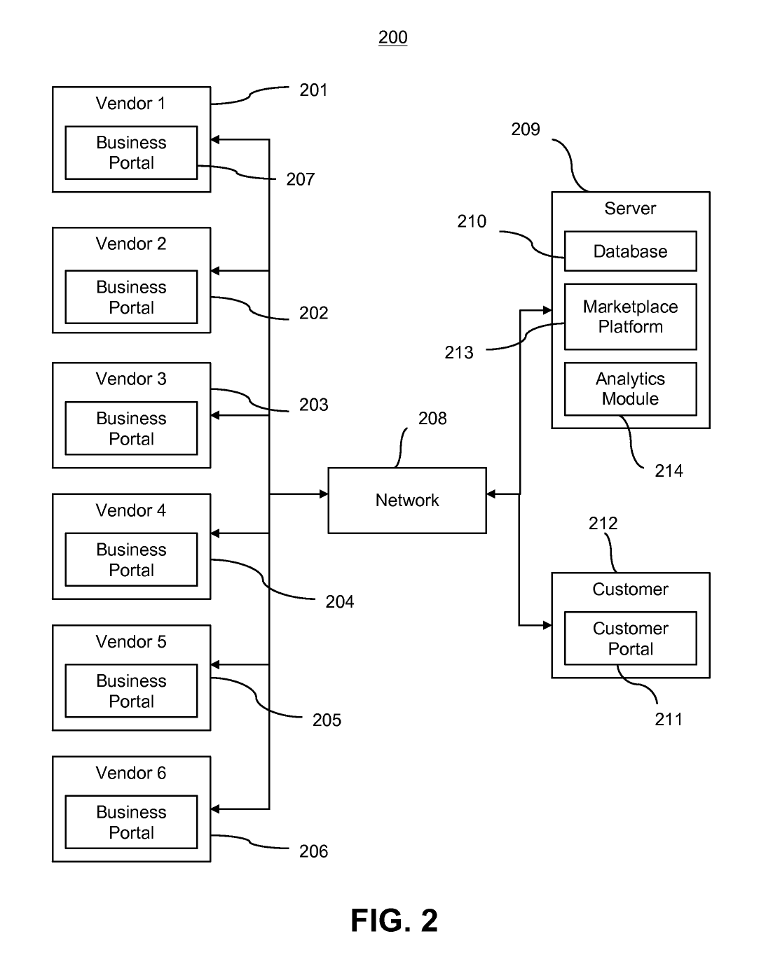

Referring now to FIGS. 1 and 2, there is shown a flow chart illustrating the present method and an exemplary schematic diagram of the present invention, respectively. The present system 200 comprises a plurality of vendor devices 201-206, at least one customer device 212, and at least one server 209 connected in a network 208, wherein the server 209 includes a server database 210, a marketplace platform 213, and an analytics module 214. In an exemplary embodiment, the present invention comprises six individual vendor devices, wherein each of the devices is associated with a vendor or a business that can provide goods or professional service. Each of the vendor devices 201-206, the customer device 212, and the server 209 comprise a standard computer system, as well as portable electronic devices having a processing unit and Internet capability, depending upon embodiment.

Accordingly, the vendor devices 201-206 provide access to a business portal 207, and the customer device 212 provides access to a customer portal 211. The business portal 207 and the customer portal 211 are components of the marketplace platform 213 provided by the server 209, wherein the marketplace platform 213 comprises a website, a web application, and/or a mobile application, depending upon embodiment.

A customer can create an RFQ for a product or professional service 101 through the customer portal 211. In creating an RFQ, the customer is prompted to: provide a title and a description of the request; select a category of a requested product and/or service; specify the start and end date and time of delivery of the product and/or service; specify the deadline for vendors or businesses to provide a quote or otherwise respond to the RFQ; and specify how the vendors should quote. For instance, businesses can quote by the hour, by the total amount or flat fee, or by the unit cost.

The customer can also indicate whether the start and end date and time for delivering the product and/or service are flexible. This would allow customers to receive, and the vendors to deliver, the requested product or service outside of the specified start and end date and time of delivery. In some embodiments, the customer can specify time flexibility by indicating that the requested product or service can be delivered outside of the start and end date and time within a predetermined time period. For instance, the customer can specify that the requested product or service can be delivered a certain number of days before and/or after the start and end date and time.

The time flexibility feature is advantageous in that it allows businesses to provide goods and/or services during off-peak or slack periods, preferably at discounted prices. For example, a salon may be overbooked and therefore unable to book the customer's appointment at the specified time in the RFQ; but the salon may be able to book the customer's appointment for a service during the time that falls within the flexible time period and offer a discounted price. This allows the vendor to gain business while allowing the customer to pay lower price for the service.

Similarly, the customer can indicate whether the vendors can offer alternate goods or products. This feature is useful when a vendor is unable to fulfill a product request for a specific item, but is able to offer a close substitute or a similar overstock item for a discounted price. By offering to provide a close substitute or a similar overstock item for a discounted price, the vendor can conduct a sale and the customer can receive suitable products at a value price. On the other hand, the customer can specify that a specialized item be used if available. For example, the customer can ask for organic products, and receive higher alternate quotes. The customer can indicate whether time flexibility and/or alternate goods or products are acceptable by including such information in the description of the RFQ or making appropriate entries.

Once the customer completes the RFQ, he or she can invite vendors, or preferred businesses, to provide a quote for the requested product and/or service 102, or otherwise respond to the RFQ. In a preferred embodiment, the customer can select up to six vendors per RFQ. The present system automatically populates a list of vendors to select from based on the category of requested product and/or service so as to allow the customer to pick vendors that are capable of delivering the requested product and/or service.

After selecting the vendors, the customer can confirm that the provided information is accurate and submit the RFQ. The RFQ is transmitted to the server 209 via the network and broadcasted to the selected vendors 103 on the marketplace platform 213. When the request is published, each of the invited vendors is notified of the RFQ and can view the request 104 through the business portal 207. Upon viewing the request, the vendor can provide a quote by inputting a bid 105 or opt out of providing a quote.

Once the bidding period is expired, the customer can select a winning vendor 106. Alternatively, the customer can manually close the bidding process by selecting a winning vendor 106 before the bidding period expires. When the customer selects a winner, the customer is prompted to complete a survey 107 before confirming the purchase 108. Thus, the survey is completed at the point of sale rather than at the point of delivery. The survey is used to provide feedback as to why the customer selected the winning vendor and to assess the performance of all of the participating vendors during the bidding process.

Without limitation, the customer can rate each vendor on price, reputation, and communication skills, among other factors. Additionally, the customer can provide comments in a free-form text field. In this way, the survey data comprises the customer's perception of each participating vendor on the following criteria: the vendor's price; the vendor's reputation; and the vendor's ability to communicate. The survey results can be transmitted to all of the vendors and made available on the business portal. The winning vendor can utilize the survey data to assess his or her performance. On the other hand, the losing vendors can utilize the survey data to analyze how he or she scaled against the winning vendor and how he or she can improve his or her performance in future biddings to increase sales.

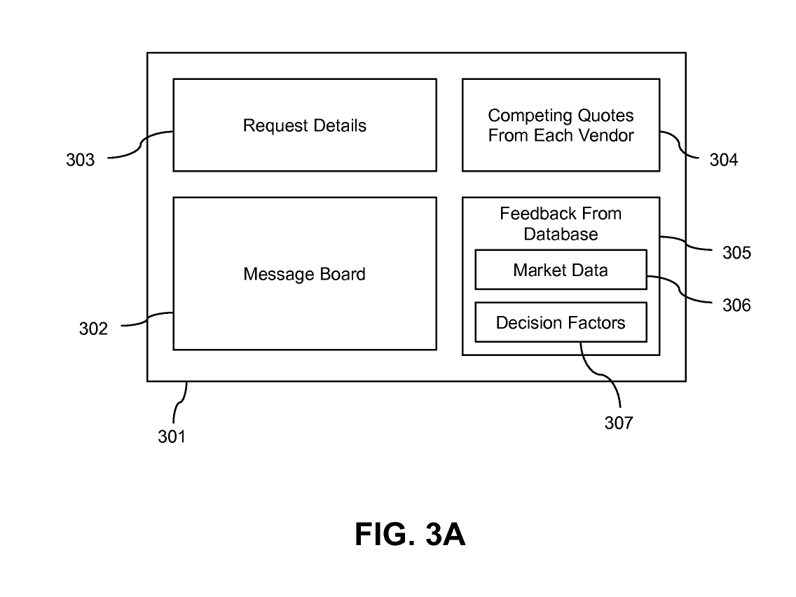

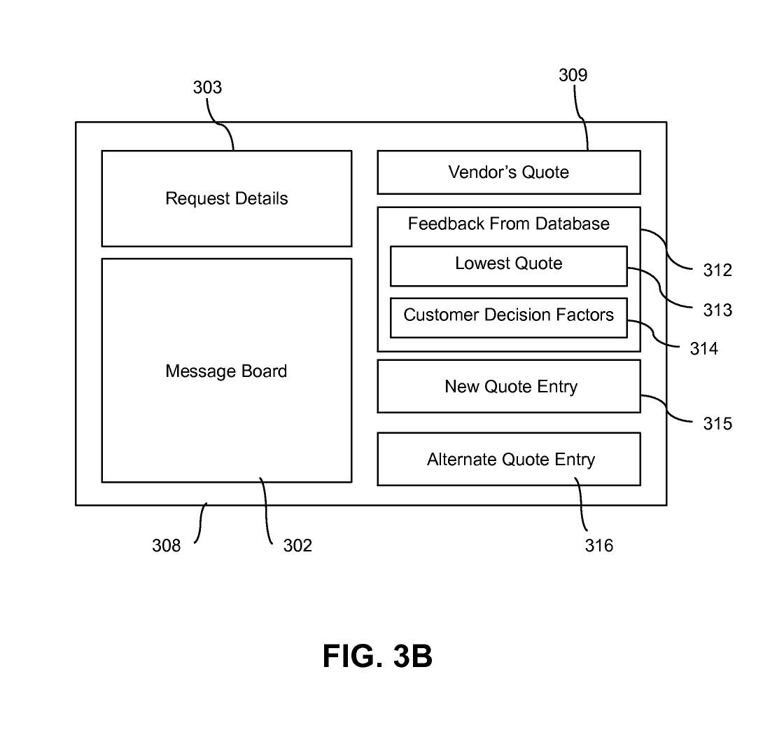

Referring now to FIG. 3A, there is shown a view of an exemplary diagram of a customer interface. The customer interface 301 comprises a section for the request details 303, which includes information regarding the request, such as the title of the request, time and date requested for the delivery of the requested product and/or service, status of the RFQ, and remaining time for the bidding, among other information. Additionally, the customer interface 301 includes a list of quotes received from each vendor 304. The list comprises information regarding each vendor, such as reviews and ratings, wherein the data for the reviews and ratings may be imported from third party databases. Additionally, the list comprises a select button next to each vendor so that the customer can quickly choose a winning vendor. The customer can also opt to view a full quote history by clicking on a hyperlink that can direct them to a quote history page.

The interface 301 further provides the customer with information from the server database 305. For instance, the customer may be provided with market data 306, which includes information that is pertinent to the RFQ, such as the average market price for the requested product and/or service. Additionally, the customer may be provided with decision factors 307 that he or she should take into consideration when selecting a vendor. The customer interface 301 also allows the customer to cancel the RFQ during the bidding process. Cancelling the RFQ will allow the bid to close immediately without awarding the job to one of the participating vendors.

The customer can communicate with all of the participating vendors via the message board 302. The messages posted on the message board 302 are visible to all of the vendors so as to allow the customer to centralize communication with the vendors and to eliminate the need for the customer to communicate with each vendor individually. This is particularly advantageous when the customer desires to make announcements to all of the participating vendors, or when answering frequently asked questions.

The message board 302 is also available on the business interface 308. In a preferred embodiment, the identities of the vendors remain anonymous to all of the participating vendors on the message board 302 so that only the customer knows the identity of the vendors. The vendors may be visible without any identification on the message board or be identified via aliases or anonymous names. The anonymity allows the vendors to maintain privacy and protects the integrity of the bidding process.

Referring now to FIG. 3B, there is shown an exemplary diagram of a business interface. Similar to the customer interface, the business interface 308 also comprises a section for the request details 303, which includes information regarding the request, such as the title of the request, time and date requested for service, status of the request, and countdown for bidding, among other information. The vendor can also view his or her latest quote 309, which is automatically updated each time the vendor inputs offers or bids. The vendor can adjust his or her quote by entering new offers or bids in a new quote entry box 315. The vendor can adjust his or her quote based on feedback received from database 312, wherein the feedback comprises the lowest quote offered 313 by a competing vendor. Additionally, the feedback comprises customer decision factors 314 that most customers consider when selecting a winning vendor. For instance, the customer decision factors 314 may comprise information on how customers weigh factors such as pricing and rating for the requested product and/or service. In this regard, the vendor can adjust his or her pricing or improve his or her rating to increase his or her chance of winning the bid.

The business interface 308 further comprises an alternate quote entry box 316. The alternate quote entry box 316 is enabled if the RFQ indicates that time flexibility and/or alternate goods or products are acceptable. Thus, if the RFQ does not indicate that the customer will allow the vendors to deliver the requested goods and/or service outside of the specified start and end date and time, or if the RFQ does not indicate that the customer will accept substitute goods, the alternate quote entry box 316 is disabled and the vendor cannot provide an alternate quote. When the alternate quote entry box 316 is enabled, the vendor may enter a regular quote in the new quote entry box 315 and offer an alternate quote in the alternate quote entry box 316. As described above, the vendor can offer a regular quote for delivering the requested goods and/or service as specified in the RFQ; and offer an alternate quote for delivering substitute goods and/or providing service at a flexible time.

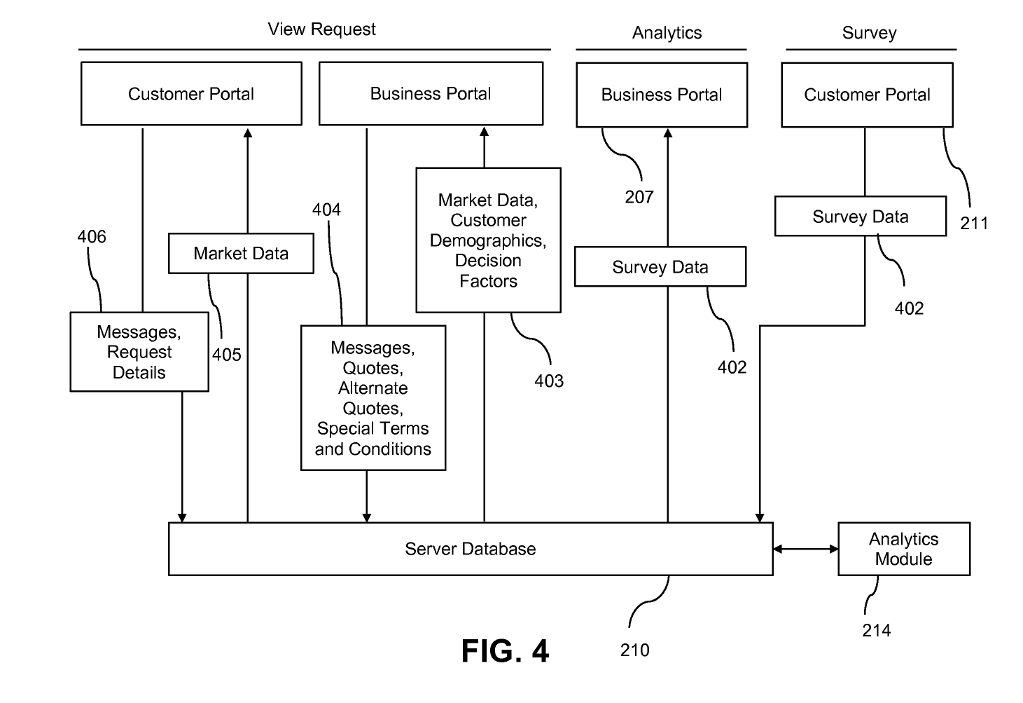

Referring now to FIG. 4, there is shown an exemplary data flow diagram of the present invention. The server database 210 is used to store various data, wherein the customer devices and the vendor devices can transmit and retrieve the data via the customer portal and the business portal, respectively. On a screen for viewing request, the customer can transmit job request details, messages, and other information pertaining to an RFQ 406 from the customer portal 211 to the server database 210. Once transmitted, the request details and message 406 are available on the marketplace platform and retrieved through the business portal 207. The customer can also retrieve data such as market data 405 and other information stored in the server database 210 and view it on the customer portal 211.

Similarly, vendors can transmit messages, quotes, alternate quotes, and special terms and conditions 404 from the business portal 207 to the server database 210. The foregoing information can be made available on the marketplace platform and retrieved through the customer portal 211. Throughout the bidding process and any time thereafter, vendors can also receive market data, customer demographics, and customer decision factors 403 to input offers or bids.

When customers complete surveys upon selecting a winning vendor, the survey data 402 is transmitted to the server database 210 and relayed to the business portal 207 so as to allow the vendors to analyze their business and competing businesses. Preferably, the survey data 402 is presented in a form of a report via the analytics module 214, wherein the report can be customized by each vendor using control features of the analytics module 214. In this regard, vendors can tailor the report to fit their needs.

It is contemplated, however, that the analytics module is not limited to generating reports based solely on the survey data 402. Without limitation, other types of data that may be collected include marketplace platform specific data such as: consumer demand for various products and services; typical consumer-business interactions for requested products and services; pricing for requested products and services; consumers' perception of participating businesses' performances during the RFQ process or at the point of sale; and key purchasing factors, among others. Additionally, broader market data such as location-based data, industry-based data, seasonal data, customer demographics, customers' values, competition data, and business ratings can be collected and provided to the vendors.

The analytics module 214 can consolidate the foregoing data and provide reports to the vendors so that they can assess their performance and make improvements. The reports can be automatically generated after a vendor participates in a bidding process and/or on a regular basis. The reports can summarize the collected data and organize it in various ways to help the vendors understand customers' needs and behavior, whereby increase of understanding can improve interactions with customers and increase sales.

In some embodiments, the analytics module 214 can generate specific suggestions or advice as to how businesses can improve marketing and grow sales, thereby enhancing overall performance. For instance, the analytics module 214 can suggest vendors to stock certain items or offer certain services based on its popularity and demand during certain times of the year. In another instance, the analytics module can calculate how much an improved rating can increase sales for similar businesses; and identify areas of weakness and shortcomings of a business. Without limitation, some areas for improvement may comprise pricing, hours of operation, and service/product quality. The business can then make specific improvements based on the identified areas of weakness and shortcomings, whereby the improvements can lead to better ratings.

Furthermore, the analytics module 214 is configured to provide information to customers and vendors about benchmark pricing, peak periods, opportunities for discounts, and the like. The information can be provided in real-time and available on the customer interface and the business interface during the bidding process. In this way, customers can make informed decisions when selecting a vendor, and vendors can make optimal bids based on the guidance provided.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An online marketplace system, comprising:
at least one vendor device, at least one customer device, and a server connected in a network;
said server having a database, an analytic module, and a marketplace platform comprising a customer portal and a business portal;
said customer portal accessible via said at least one customer device;
said business portal accessible via said at least one vendor device;
said marketplace platform configured to receive a request for quote from said at least one customer device through said customer portal and receive bids from said at least one vendor device through said business portal;
said analytics module configured to transmit market data to said at least one customer device and said at least one vendor device in real-time.

2. The system of claim 1, wherein said business portal provides access to a business interface;
wherein said customer portal provides access to a customer interface.

3. The system of claim 2, wherein each of said business interface and said customer interface comprises request details and a message board;
said message board configured to post all messages transmitted from said at least one vendor device and said at least one customer device.

4. The system of claim 3, wherein said customer interface further comprises: competing quotes from each vendor, and feedback from said database.

5. The system of claim 3, wherein said business interface further comprises: a vendor's quote, feedback from said database, a new quote entry box, and an alternate quote entry box.

6. The system of claim 5, wherein said alternate quote entry box is activated when said request details specify that time flexibility is acceptable.

7. The system of claim 5, wherein said alternate quote entry box is activated when said request details specify that a substitute goods is acceptable.

8. The system of claim 1, wherein said analytics module is further configured to transmit survey data to said at least one vendor device.

9. The system of claim 1, wherein said analytics module is further configured to make suggestions based on said survey data and said market data.

10. A method implemented at least in part via a processing unit, comprising the steps of:
creating a request for quote, wherein said request for quote includes provide a title and a description of a requested product or service, a category of said requested product or service, start and end date and time of delivery of said requested product or service, and a deadline for providing a quote or otherwise respond to the RFQ;
selecting a plurality of vendors based on said category;
broadcasting said request for quote to said plurality of vendors on a marketplace platform;
viewing said request for quote on a business portal of said marketplace platform;
inputting a bid through said business portal;
declaring one of said plurality of vendors as a winner;
completing a survey, wherein said survey collects data regarding a vendor's price, a vendor's reputation, and a vendor's ability to communicate;
confirming a purchase.

11. The method of claim 10, wherein creating said request for quote comprises the steps of specifying whether time flexibility or substitute goods is acceptable.

12. The method of claim 11, further comprising the steps of inputting an alternate bid based on said time flexibility or said substitute goods.

13. The method of claim 10, wherein inputting said bid further comprises the steps of updating said bid based on market data.

14. The method of claim 10, further comprising the steps of generating a report via an analytics module.

15. The method of claim 10, further comprising the steps of transmitting results of said survey to said plurality of vendors.
